(19) United States
(12) Patent Application Publication
(10) Pub. No.: US 2003/0138147 A1
(43) Pub. Date: Jul. 24, 2003

(54) Object recognition system for screening device

(76) Inventor: Yandi Ongkojoyo, Boston, MA (US)

Correspondence Address: YANDI ONGKOJOYO, 517 Hancock St Apt #21, Quincy, MA, 02170, US

(21) Appl. No.: 10/052,018

(22) Filed: Jan. 17, 2002

(51) Int. Cl. G06K 9/62

(52) U.S. Cl. 382/224

(57) ABSTRACT

Electronic Object Detection, the system and method of this invention can recognize objects in images or data acquired from a screening device and mark said objects if they can be hazardous. It is very useful to help the operators of said screening device to do their job more effectively and more efficiently.

It acquires its input from any TWAIN-compatible digital imaging device comprising screening device with a video to USB adaptor. The data from said device is pre-processed to enhance its quality. The enhancement of these digital images comprises dilation, image-depth conversion, and gray scaling. After the enhancement process, information about each object is extracted from the image.

Using this information, each object is recognized using an object recognition engine tolerant to size and rotation. A monitor hierarchically displays the actual data and the information about the class of each object, its location, and its hazard level.

### CROSS-REFERENCE TO RELATED APPLICATIONS

### BACKGROUND OF THE INVENTION

Not applicable.

This invention relates generally to image and document image understanding, and more particularly to a system that can detect or recognize certain objects in a screening process.

Screening for hazardous objects using a screener device is a very demanding task that requires both accuracy and efficiency. Human factors comprising sleepiness, fatigue, boredom, and inadequate training may affect the ability of a person to do this task accurately and efficiently. Unfortunately, this kind of failures may potentially lead to a disaster.

Upgrading the screener device may increase the overall performance. However, it is an expensive solution and does not guarantee that personnel with inadequate training or poor mental condition can do the task well enough.

Although in near future nothing can substitute a state of the art screening device with a well-trained personnel in his or her tip-top shape, this system could potentially compensate some error made by less qualified device or personnel. To begin with, this system can be trained to recognize and mark potentially hazardous objects for further, more careful examination by the operator of the screening device. Moreover, the system can be interfaced with any TWAIN-compliant device. This means that with a suitable adaptor and driver, the system can be interfaced with the screening devices already being used.

### SUMMARY OF THE INVENTION

The primary object of the invention is to recognize potentially hazardous objects during a screening process.

Another object of the invention is to minimize screener's failure to recognize or to detect potentially hazardous objects during a screening process by recognizing and marking said objects automatically when they are displayed on a monitor.

The system and method of this invention recognize objects trained by the user. Said system categorizes said objects into several classes, and marks said objects according to their classes. The system displays the representation of the recognized objects hierarchically. Each parent node displays a class of objects. Said user may expand said parent node to display the representation of said recognized objects that belong to that class. Once displayed, said user may choose the representation of an object to pinpoint the location and the class of said object.

The system comprises an image processing subsystem, a recognition subsystem, and a training subsystem.

The image processing subsystem acquires an image from a screening or image acquisition device such as an x-ray screening device by using standard TWAIN protocol. For a device without any compatible interfaces, a special adaptor that convert the available interface to a supported interfaces such as universal serial bus or parallel port along with an appropriate driver can be used. The image acquired from the device is processed further to increase the performance of the system.

The object recognition subsystem uses the information acquired and processed by the image processing subsystem about the objects and their locations. The object recognition subsystem determines the boundary of each object in the image and recognizes them by using a pattern recognition engine tolerant to rotation and size. The object recognition subsystem recognizes each object in the image and categorizes each recognized object into object classes.

The training subsystem is used to teach the object recognition subsystem to recognize new kinds of objects and re-learn old objects.

### BRIEF DESCRIPTION OF THE DRAWINGS

The foregoing features and other aspects of this invention will now be described in accordance with the drawings in which:

FIG. 1 is a diagram of the suggested application and requirement or configuration of the system to be used with a screening device.

FIG. 2 is a UML diagram of key elements in the system.

FIG. 3 is a diagram of the neural networks used to recognize pattern in the object recognition engine in the system.

### DETAILED DESCRIPTIONS OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

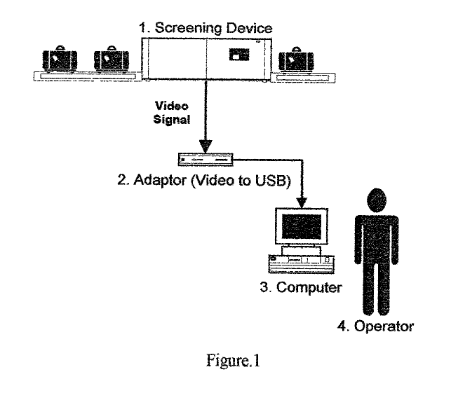

Referring now to FIG. 1, the system is shown to comprise a screening device 1. Said screening device 1 comprises a generic x-ray screening device.

The system is shown to further comprise an adaptor 2. Said adaptor 2 converts video signal output from said screening device 1 to digital format. Said digital format follows standard and port that can be recognized by the system.

The system is shown to further comprise a computer system 3. The computer system 3 comprises personal computer that can run the software part of the system. Said computer system 3 displays data from said screening device 1 and pinpoints objects said computer system 3 recognizes as hazardous objects.

An operator 4 operates the system. Said operator 4 performs more thorough checking whenever the system detects possible hazardous objects.

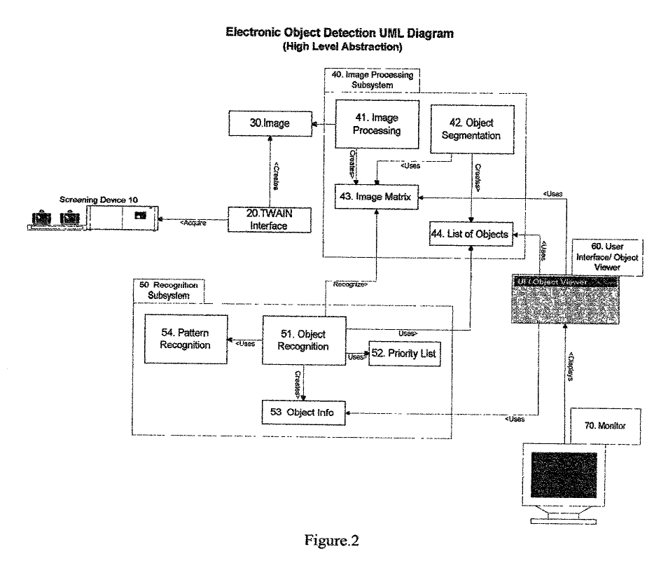

Referring now to FIG. 2, the UML diagram of the system is shown to comprise TWAIN interface 20. Said TWAIN interface may control data acquisition from any TWAIN-compatible image acquisition device comprising a screening device 10. Said TWAIN interface then produces an image 30 of the actual objects being screened.

The system is shown to further comprise an image-processing subsystem 40, which comprises an image processing engine 41 and an object recognition engine 42.

Said image-processing engine 41 receives said image 30 and applies image-processing techniques to enhance the quality of said image 30. Said image-processing techniques comprise dilation, image-depth conversion, and gray scaling. Said image-processing engine 41 converts said image 30 into several two-dimensional array image matrixes 43. Each image matrix 43 comprises a filtered version of said image.

The object-segmentation engine 42 uses image matrix 43 to get the boundary of each object. The object-segmentation engine stores the information about said boundary of each object in a list of objects 44.

The system is shown to further comprise a recognition subsystem 50, which comprises an object recognition engine 51.

The object recognition engine 51 receives said image matrix 43 and said list of objects 44. The object recognition engine 51 retrieves the representation of each object in said image matrix 43 using data from said list of objects 44. The object recognition engine 51 produces object info 53 comprising the class and the hazard level of each object using a priority list 52. Said priority list 52 comprises a list of all classes of objects and their hazard levels. The object recognition engine 51 uses pattern recognition engine 54. Said pattern recognition engine 54 is a neural network pattern recognition engine tolerant to rotation and scaling.

The system is shown to further comprise a user interface/object viewer 60. The user interface/object viewer 60 displays the class of each object recognized by said object recognition engine 51 hierarchically, grouped by their hazard levels. Said user interface/object viewer 60 pinpoints an associated object if a user chooses a class that represents that object. The way user interface/object viewer 60 pinpoints an object depends on the hazard level of that object. A monitor 70 displays the user interface/object viewer to said user.

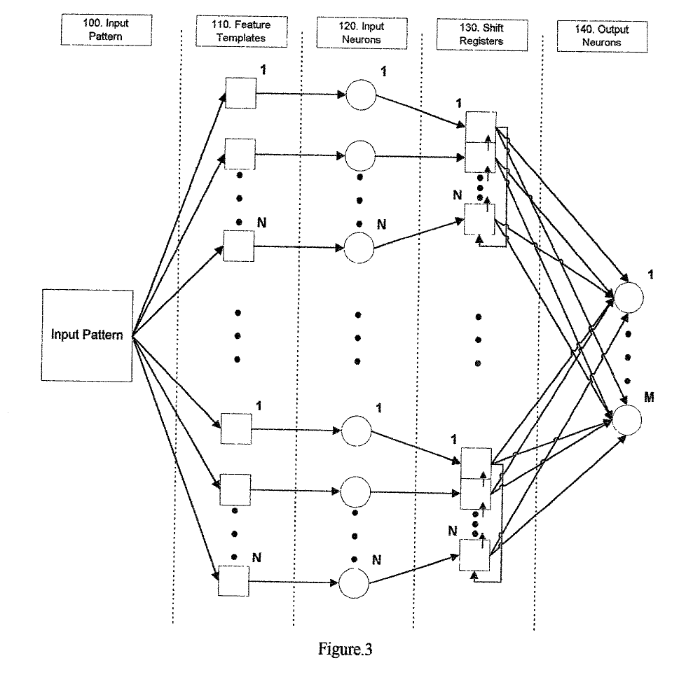

Referring now to FIG. 3, the diagram of the artificial neural networks used to recognize pattern in the object recognition engine in the system shown to comprise input pattern 100. Said input pattern 100 is the pattern that will be recognized by the neural networks. Each pattern is a representation of an object the recognition system is trying to recognize.

The neural network is shown to further comprise feature templates layer 110. Feature templates 110 are used to extract certain features from said input pattern 100. Feature templates 110 are arranged in several clusters, each cluster has the same number of templates.

The neural network is shown to further comprise input neurons 120. Said input neurons 120 form an input layer. Each neuron in said input neurons 120 receives input from the result of feature extraction by a template in said feature templates 110 layer. Said input neurons are arranged in several clusters, each cluster has the same number of neurons. The number of neurons in each cluster is equivalent to the number of templates in a cluster in said feature templates 110.

The neural network is shown to further comprise shift registers or ring buffers 130. Each shift register contains a certain number of elements. Each element receives input from a neuron in said input layer 120. The number of elements in each shift register is equivalent to the number of neurons in a cluster in said input layer 120.

The neural network is shown to further comprise output neurons 140. Said output neurons 140 form an output layer. Many kinds of neural networks can be used in this layer, comprising variants of multiplayer perceptrons (MLP) and variants of radial basis function (RBF) networks. This output layer receives input from said shift registers 130.

While the invention has been described in connection with a preferred embodiment, it is not intended to limit the scope of the invention to the particular form set forth. On the contrary, it is intended to cover such alternatives, modifications, and equivalents as may be included within the spirit and scope of the invention as defined by the appended claims.

What is claimed is:

1. A system, method and computer program that receives data from an image acquisition device comprising a regular x-ray screening device, tries to recognize each object in said data, and pinpoints each object it is trained to recognize along with its class and hazard level.

2. The system of claim 1 further comprises a different kind or more sophisticated image acquisition device comprising x-ray body scanner and infrared scanner.

3. The system of claim 1 further comprises a different or more sophisticated image processing, image correction, and image enhancement engine.

4. The system of claim 1 further comprises a different or more sophisticated object recognition engine.

5. The method of claim 1 further comprises other kinds of user interfaces, comprising audio output.

6. A computer program product having a computer readable medium having computer program logic recorded thereon that receives data from an image acquisition device comprising a regular x-ray screening device, try to recognize each object in said data, and pinpoint each object it is trained to recognize along with its class and hazard level.

7. The computer program of claim 6 wherein said program further comprises a remote database.

8. The computer program of claim 6 wherein said program further comprises distributed processing.

9. A neural networks structure having shift registers or ring buffers that exchanges the input to neurons in a layer.

10. The neural networks structure of claim 9 wherein said structure further comprises competitive learning or layer.

11. The neural networks structure of claim 9 wherein said structure further comprises normalization.
